(19) United States
(12) Patent Application Publication
(10) Pub. No.: US 2026/0236844 A1
(43) Pub. Date: Aug. 13, 2026

(54) NETWORKED SYSTEM AND INFORMATION PROCESSING METHOD

(71) Applicants: Kristopher Andrew TATE, Kyoto-shi, Kyoto (JP); CONNECTFREE CORPORATION, Kyoto-shi, Kyoto (JP)

(72) Inventor: Kristopher Andrew TATE, Kyoto-shi, Kyoto (JP)

(73) Assignees: Kristopher Andrew TATE, Kyoto-shi, Kyoto (JP); CONNECTFREE CORPORATION, Kyoto-shi, Kyoto (JP)

(21) Appl. No.: 19/479,983

(22) PCT Filed: May 22, 2025
(86) PCT No.: PCT/JP2025/018578

§ 371 Date: Oct. 29, 2025

(30) Foreign Application Priority Data
Feb. 10, 2025 (JP) 2025-020222

(51) Int. Cl. G06N 20/00; H04L 9/08

(52) U.S. Cl. CPC G06N 20/00; H04L 9/08

(57) ABSTRACT

A networked system includes a plurality of machine learning processing engines. Each of the plurality of machine learning processing engines is configured to operate on one or more computing devices. Each of the plurality of machine learning processing engines includes an identifier for identifying another machine learning processing engine using a cryptographic method. Each of the plurality of machine learning processing engines executes a model operation by exchanging information with another machine learning processing engine according to an interrelationship between the identified another machine learning processing engine and the machine learning engine itself.

### CROSS-REFERENCE TO RELATED APPLICATIONS

This application is a National Stage Application of PCT/JP2025/018578, filed May 22, 2025, which claims benefit of priority to Japanese Patent Application No. 2025-020222 filed on Feb. 10, 2025, and which applications are incorporated herein by reference. To the extent appropriate, a claim of priority is made to each of the above disclosed applications.

### TECHNICAL FIELD

The present disclosure relates to a networked system including a plurality of machine learning processing engines and an information processing method in the networked system.

### BACKGROUND ART

As a solution to the problems related to network addresses in the existing Internet, WO2020/049754 (Patent Document 1) discloses a completely new method for determining network addresses using public keys.

Patent Document 1: WO2020/049754

### Problem To Be Solved by the Invention

The present disclosure provides a novel networked system that includes a plurality of machine learning processing engines.

### SUMMARY OF THE INVENTION

A networked system according to an aspect of the present disclosure includes a plurality of machine learning processing engines. Each of the plurality of machine learning processing engines is configured to operate on one or more computing devices. Each of the plurality of machine learning processing engines includes an identification means for identifying another machine learning processing engine using a cryptographic method. Each of the plurality of machine learning processing engines executes a model operation by exchanging information with the another machine learning processing engine according to an interrelationship between the identified another machine learning processing engine and the machine learning engine itself.

Each of the plurality of machine learning processing engines may further include a determination means for determining, in accordance with a predetermined setting, an authority to be granted to the identified another machine learning processing engine.

The predetermined setting may associate a network address of another machine learning processing engine with one or more authorities to be granted to the another machine learning processing engine.

Each of the plurality of machine learning processing engines may have a setting in which information indicating another machine learning processing engine is associated with a network address of the another machine learning processing engine.

The identification means may authenticate a network address of the another machine learning processing engine. Each of the plurality of machine learning processing engines may have a private key used for identification by the cryptographic method.

The model operation includes at least one of data collection, preprocessing of collected data, model training, model evaluation, model deployment, inference using a model, monitoring of model performance, model maintenance, and model retraining.

According to another aspect of the present disclosure, there is provided an information processing method in a system including a plurality of machine learning processing engines. Each of the plurality of machine learning processing engines is configured to operate on one or more computing devices. The information processing method includes: a step in which each of the plurality of machine learning processing engines identifies another machine learning processing engine using a cryptographic method, and a step in which each of the plurality of machine learning processing engines executes a model operation by exchanging information with the another machine learning processing engine according to an interrelationship between the identified another machine learning processing engine and the machine learning engine itself.

According to the present disclosure, a novel networked system that includes a plurality of machine learning processing engines is provided.

### BRIEF DESCRIPTION OF DRAWINGS

FIG. 1 is a flowchart showing an example of a process of determining a network address in each node of a networked system according to an embodiment of the present embodiment;

FIG. 2 is a sequence diagram showing an example of a process of authenticating a network address between nodes in the networked system according to the present embodiment;

FIG. 3 is a schematic diagram showing an example of the hardware configuration of a node according to the present embodiment;

FIG. 4 is a schematic diagram showing an example of the configuration of the networked system according to the present embodiment;

FIG. 5 is a schematic diagram showing a more detailed configuration example of a machine learning processing engine shown in FIG. 4;

FIG. 6 shows an example of setting authority in the networked system according to the present embodiment;

FIG. 7 is a diagram showing an example of a model operation of the machine learning processing engine according to the present embodiment;

FIG. 8 is a schematic diagram showing an example of implementation of the machine learning processing engine according to the present embodiment;

FIG. 9 is a schematic diagram showing an example of sharing core parameters according to the present embodiment; and

FIG. 10 is a diagram showing a configuration example in which a plurality of nodes access the machine learning processing engine according to the present embodiment.

### DETAILED DESCRIPTION

Embodiments of the present disclosure will be described in detail with reference to the diagrams. In addition, the same or corresponding portions in the diagrams are denoted by the same reference numerals, and description thereof will not be repeated.

### A. Overview

A networked system according to the present embodiment includes a plurality of machine learning processing engines. At least one machine learning processing engine can exchange information with other machine learning processing engines to perform model operations.

The machine learning processing engine includes, for example, a machine learning model (hereinafter, also simply referred to as a “model”). Model operations include, for example, data collection, preprocessing of collected data, model training, model evaluation, model deployment, inference using the model, monitoring of model performance, model maintenance, and model retraining. In addition, only some of the specific examples of the exemplified model operations may be implemented.

The models of the machine learning processing engine include, for example, neural networks (for example, convolutional neural networks, recurrent neural networks, and the like), regression models (for example, linear regression, polynomial regression, and the like), classification models (for example, logistic regression, support vector machines, decision trees, random forests, and the like), clustering models (for example, K-means clustering, hierarchical clustering, and the like), dimensionality reduction models (for example, principal component analysis, t-SNE, and the like), and reinforcement learning models (for example, Q learning, Deep Learning, and the like).

The machine learning processing engine may be able to perform training, for example, supervised learning, unsupervised learning, reinforcement learning, and the like. In the machine learning processing engine, training may be performed to update the parameters of some or all of the models in the machine learning processing engine, or to cause a change in the state of some or all of the models in the machine learning processing engine.

The tasks of the machine learning processing engine may be, for example, classification (for example, binary classification, multi-class classification, and the like), regression (for example, prediction of continuous values), clustering, anomaly detection, dimensionality reduction, reinforcement learning, and the like.

### B. Network Address Authentication Scheme

Next, a network address authentication scheme (hereinafter, also simply referred to as “authentication scheme”) used by the networked system according to the present embodiment will be described.

### (b1: Acquisition of a Network Address in a Host Node)

Each node has a cryptographically determined network address. The entire network address of each node may be determined cryptographically.

In this specification, “network address” means identification information for identifying a node on a network, and may be a unique address system (an address with an arbitrary length can be adopted) without being limited to commonly used IP (Internet Protocol) addresses (IPv4 and IPv6).

In the present embodiment, as an example of a method for cryptographically determining a network address, a public key of each node and an irreversible cryptographic hash function (hereinafter, also simply referred to as “hash function ”) are used.

Any hash function may be used as long as the hash function is common between nodes. For example, BLAKE or Keccak may be used. In addition, any cryptographic hash function developed in the future may be adopted.

A public key is input to a hash function to calculate a hash value. A network address is determined using all or part of the calculated hash value. For example, the entire network address may be determined from the hash value alone. In this case, the network address may be designed so that a hash value with a length equal to or greater than the number of digits (or bits) required for the network address is calculated.

For example, when determining an IP address of IPv6, it is sufficient to calculate a hash value of at least 128 bits, and when determining an IP address of IPv4, it is sufficient to calculate a hash value of at least 32 bits. When a public key with which a 256-bit or 512-bit hash value can be calculated is prepared, any 128-bit (or 32-bit) portion of the calculated hash value may be extracted and determined as the network address.

As a modification example, a network address may be determined by adding a predetermined value to the calculated hash value. For example, a hash value with a predetermined bit length may be determined as a network address by changing the value of a specific digit (or a specific bit position) to a predetermined value (for example, a value indicating a specific attribute).

As a modification example, instead of the public key itself, a public key with a specific character string added or a public key modified with a specific character string may be input to the hash function. The specific character string may be, for example, the name of an organization associated with the network address or a trademark owned by the organization.

By using such cryptographically determined network addresses, it is possible to authenticate network addresses between nodes. That is, each node authenticates the network address of the communication partner to ensure the authenticity of the communication partner.

In the present embodiment, each node can autonomously determine or generate its own network address. Hereinafter, a process of determining a network address in each node will be described.

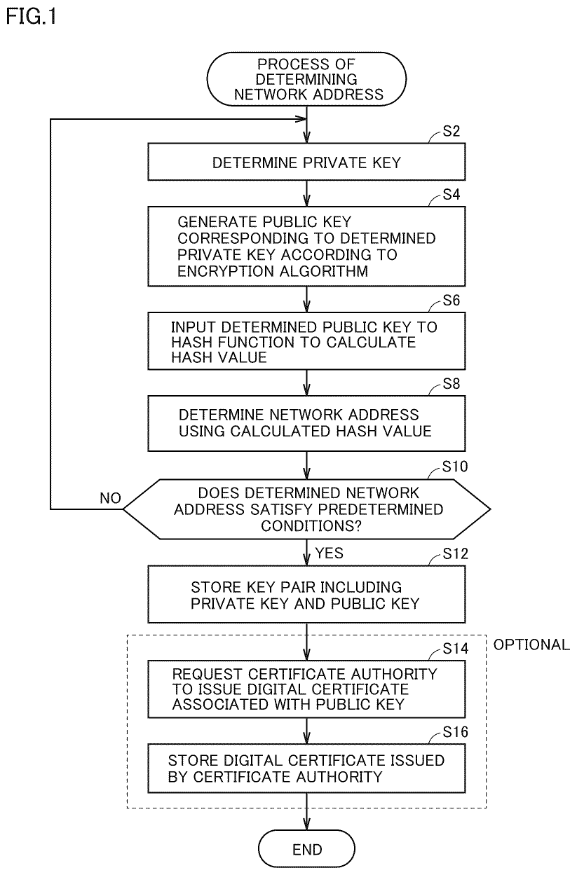

FIG. 1 is a flowchart showing an example of a process of determining a network address in each node of the networked system according to the present embodiment.

Referring to FIG. 1, the node determines a private key (step S2). The node may generate the private key using any pseudo-random number generation algorithm, or may acquire the private key from the outside. The node generates a public key corresponding to the determined private key according to an encryption algorithm (step S4).

The node inputs the determined public key to a hash function to calculate a hash value (step S6), and determines a network address using the calculated hash value (step S8).

The node determines whether or not the determined network address satisfies predetermined conditions (step S10).

The predetermined conditions may include that the determined network address conforms to the network address rules. Specifically, the predetermined conditions may include that one or more specific digits (or one or more specific bits) of the determined network address indicate a predetermined value. For example, when the first two digits (16 bits in an 8-bit representation) of the determined network address indicate “FC”, it may be determined that the predetermined conditions are satisfied.

The predetermined conditions may include not being the same as (or conflicting with) the network address of another node.

If the predetermined conditions are not satisfied (NO in step S10), the processing from step S2 is repeated. At this time, the previously determined or generated private key and public key may be discarded.

If the predetermined conditions are satisfied (YES in step S10), the node stores a key pair including the private key and the public key (step S12).

The processes in steps S2 and S4 may be substituted, for example, by generating a key pair (private key and public key) using a TPM (Trusted Platform Module).

In step S12, only the private key may be stored. In this case, if necessary, a public key corresponding to the stored private key may be generated each time. Thus, each node stores at least a private key that is used for identification using a cryptographic method.

The determination of whether or not the predetermined conditions are satisfied in step S10 may correspond to, for example, a process for ensuring that the determined network address conforms to the network rules. Depending on the network in which the network address is used, there may be a case where no rules are set, and in such a case, the determination in step S10 may be skipped or substantially invalidated. For example, the determination in step S10 itself may be omitted, or any network address may be determined to satisfy the predetermined conditions.

The key pair stored by the above process is used for a long period of time, and is therefore also referred to as a “static key pair” below. As will be described later, in the handshake for establishing an encrypted session, a key pair for temporary use (hereinafter, also referred to as an “ephemeral key pair”) is generated separately from the static key pair.

(b2: Issuance of a Digital Certificate Associated with a Public Key)

The network address and key pair required for the authentication scheme are determined by the above process, but the following process may be performed as necessary. That is, a digital certificate associated with the public key may be prepared. The use of such a digital certificate further guarantees the authenticity of the public key.

Specifically, the node requests the certificate authority to issue a digital certificate associated with the public key (step S14). The node stores the digital certificate issued by the certificate authority (step S16). In addition, the node may receive the digital certificate directly from the certificate authority, or may acquire the digital certificate issued by the certificate authority by any method. The digital certificate may be registered in the certificate authority or a repository associated with the certificate authority.

The digital certificate includes digital certificate information and signature value. The digital certificate information includes, for example, the following information.
Name of issuer
Name of subject
Subject public key
Validity

For example, as the name of the issuer, the name of the certificate authority may be stored. As the name of the subject, the name of the node or the user name of the node may be stored. As the public key of the subject, a value of the public key of the node may be stored. As the validity, a start date and time and an end date and time may be stored. The length of the validity can be set arbitrarily. For example, a period that is considered to be cryptographically secure may be set. Alternatively, the validity may be determined from a commercial perspective. For example, the validity may be determined according to the period for which the user who uses or manages the node has paid or is scheduled to pay the usage fee.

The certificate authority calculates a hash value of the digital certificate information by using the private key of the certificate authority. A signature is generated from the calculated hash value.

The digital certificate information may include information indicating the signature algorithm used to calculate the signature. The digital certificate information may include the public key of the issuer (for example, the certificate authority). Since the digital certificate includes the public key of the issuer, the validity of the digital certificate can be checked sequentially from the intermediate certificate authority to the root certificate authority according to the certificate chain.

The certificate authority may provide the issued digital certificate to the node and register the issued digital certificate in a repository. The repository may be provided by a certificate authority other than the certificate authority that issues the digital certificate.

As described above, the issuance of a digital certificate associated with the public key of each node is an optional process.

### (b3: Encryption Session)

Next, a process example for establishing an encrypted session between nodes will be described.

An encrypted session may be established between node pairs between which data is exchanged. For example, when nodes A, B, and C exchange data with each other, a total of three encrypted sessions may be established between the node A and the node B, between the node B and the node C, and between the node C and the node A.

The process of establishing the encrypted session may include a process based on asymmetric cryptography. Network addresses may be authenticated by the process based on asymmetric cryptography. Any asymmetric cryptography may be used. For example, elliptic curve cryptography or RSA cryptography can be used. The asymmetric cryptographic algorithm may be any algorithm developed in the future.

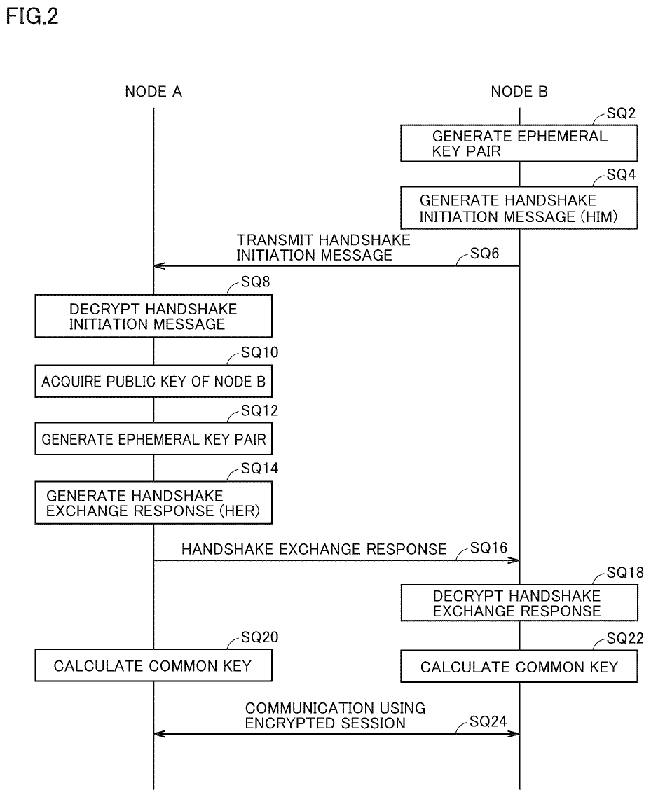

FIG. 2 is a sequence diagram showing an example of a process of establishing an encrypted session between nodes in a networked system according to the present embodiment. diagram shown in FIG. 2, it is assumed that the network address of node A, which is cryptographically determined from the static public key SP_A, is known to node B.

Referring to FIG. 2, the node B generates an ephemeral key pair (sequence SQ2). The ephemeral key pair includes ephemeral private key EPr_B and public key EP_B. The node B generates a handshake initiation message (HIM) (sequence SQ4). The handshake initiation message is a request to establish an encrypted session with the node A.

The handshake initiation message includes, for example, the following three pieces of data.
(1) Ephemeral public key EP_B (plaintext)
(2) Encrypted static public key SP_B of node B (encryption key: ECDH(EPr_B, SP_A))
(3) Encrypted timestamp (encryption key: ECDH(SPr_B, SP_A))

The data may be encrypted using an algorithm such as ChaCha20-Poly1305. ChaCha20-Poly1305 provides data confidentiality, integrity, and authenticity at the same time.

ECDH( ) means a function shown in the cryptographic algorithm for ECDH (Elliptic curve Diffie-Hellman) key sharing. The function ECDH( ) outputs the shared key.

The node B transmits the generated handshake initiation message to the node A (sequence SQ6).

The node A decrypts the handshake initiation message (sequence SQ8). Decrypting the handshake initiation message includes, for example, the following processing.
(1) The encryption key of the encrypted static public key SP_B of the node B is ECDH(EPr_B, SP_A). Taking advantage of the symmetry of ECDH(EPr_B, SP_A)=ECDH(SPr_A, EP_B), the node A calculates an encryption key using the ephemeral public key EP_B of the node B included in the handshake initiation message and the static private key SPr_A of the node A. Then, the node A decrypts the encrypted static public key SP_B of the node B using the determined encryption key.
(2) The encryption key for the encrypted timestamp is ECDH(SPr_B, SP_A). Taking advantage of the symmetry of ECDH(SPr_B, SP_A)=ECDH(SPr_A, SP_B), the node A calculates an encryption key using the static public key SP_B of the node B obtained by decryption and the static private key SPr_A of the node A. Then, the node A decrypts the encrypted timestamp using the determined encryption key.

Through the above process, the node A acquires the ephemeral public key EP_B and the static public key SP_B of the node B. In addition, when the ephemeral public key EP_B or the static public key SP_B of the node B cannot be acquired or when the timestamp indicates an invalid value, the node A may stop the process of establishing the encrypted session.

The node A acquires the static public key SP_B of the node B (sequence SQ10). The node A may cryptographically determine the network address of the node B based on the static public key SP_B of the node B that has been acquired. The network address of the node B may be determined using all or part of the hash value calculated by inputting the static public key SP_B of the node B to the hash function, as described above.

The node A generates an ephemeral key pair (sequence SQ12). The ephemeral key pair includes ephemeral private key EPr_A and public key EP_A. The node B generates a handshake exchange response (HER) (sequence SQ14). The handshake exchange response is a request to establish an encrypted session with the node A.

The handshake exchange response includes, for example, the following two pieces of data.
(1) Ephemeral public key EP_A (plaintext)
(2) Predetermined character string (encrypted with encryption key=ECDH(EPr_A, EP_B) AND ECDH(SPr_A, SP_B))

The predetermined character string is a character string that is known between the node A and the node B. For example, the predetermined character string may be an empty character string.

The node A transmits the generated handshake initiation message to the node A (sequence SQ16).

The node A decrypts the handshake exchange response (sequence SQ18). Decrypting the handshake exchange response includes, for example, the following processing.

The encryption key of the encrypted predetermined character string is ECDH(EPr_A, EP_B) AND ECDH(SPr_A, SP_B). Taking advantage of the symmetry of ECDH(EPr_A, EP_B)=ECDH(EPr_B, EP_A) and the symmetry of ECDH(SPr_A, SP_B)=ECDH(SPr_B, SP_A), the node B calculates an encryption key using the static public key SP_A of the node A, the ephemeral private key EPr_B of the node B, and the static private key SPr_B of the node B in addition to the ephemeral public key EP_A of the node A included in the handshake exchange response. Then, the node B decrypts the encrypted predetermined character string using the determined encryption key. The node B may stop the process of establishing the encrypted session if the decrypted result does not match the predetermined character string.

The node A calculates a common key to be used in the encrypted session (sequence SQ20). The node B calculates a common key to be used in the cipher session (sequence SQ22). The common key calculated by each of the node A and the node B may be based on at least a part of the shared key shown below. The left side of each equation shown below is the shared key calculated at node A, and the right side is the shared key calculated at node B.
(1) ECDH(EPr_A, SP_B)=ECDH(SPr_B, EP_A)
(2) ECDH(SPr_A, SP_B)=ECDH(SPr_B, SP_A)
(3) ECDH(EPr_A, EP_B)=ECDH(EPr_B, EP_A)
(4) ECDH(SPr_A, EP_B)=ECDH(EPr_B, SP_A)

For example, the result of concatenating the four shared keys calculated by (1) to (4) may be the common key used in the encrypted session, or the result of logical operation of the four shared keys may be the common key used in the encrypted session. Thus, the common key used in the encrypted session may be based on a combination of an ephemeral key pair and a static key pair.

The node A and the node B start communication using the encrypted session based on the calculated common key (sequence SQ24). The node A and the node B may determine identification information (for example, a session ID) for identifying the established encrypted session.

The node A and the node B may have different session IDs for the same encrypted session.

A first common key used when transmitting data from one node to another node and a second common key used when transmitting data from another node to one node may be prepared independently as common keys. In this case, a plurality of types of common keys may be generated, for example, by changing the order in which the four shared keys calculated by (1) to (4) above are concatenated.

As described above, in order to establish the encrypted session between nodes, after exchanging public keys between nodes, the common keys calculated at each node based on the asymmetric encryption algorithm need to match each other. A successful process for establishing such an encrypted session authenticates at least the public key of the communicating node. As a result, the network address of the communicating node, which is uniquely determined from the public key of the communicating node, is also authenticated.

The processes of sequences SQ2 to SQ24 may be implemented in Layer 3 (network layer) of the OSI (Open Systems Interconnection) reference model. In addition, the processes of sequences SQ2 to SQ24 may use the function of Layer 3 for implementing existing IP addresses.

Ephemeral key pairs may be updated sequentially when predetermined conditions are satisfied. When updating the ephemeral key pair, a similar exchange of handshake initiation message and handshake exchange response may occur. The predetermined conditions may include, for example, at least one of the following: the total amount of data exchanged using one ephemeral key pair has reached a predetermined value (for example, 100 MB) and a predetermined time (for example, 5 minutes) has passed from the generation of one ephemeral key pair. When the ephemeral key pair is updated, the shared key is also updated.

When a pre-shared key (PSK) can be used between nodes, the encryption strength may be increased by using the pre-shared key. As described above, when the encrypted session is established between nodes, the two nodes corresponding to the encrypted session each hold a common key. Each node may hold the common key shared with another node as a pre-shared key until the next time an encrypted session is established with another node. The common key shared in the previous encrypted session as described above may be a pre-shared key.

For example, when two nodes having a pre-shared key re-establish the encrypted session, the handshake initiation message may include a request to check the existence of the pre-shared key. When a pre-shared key is available, the generated handshake exchange response may be further encrypted using the pre-shared key in generating the handshake exchange response (sequence SQ14 in FIG. 2). A node that receives the handshake exchange response decrypts the handshake exchange response using the pre-shared key.

When common keys are updated sequentially, each node may hold a plurality of pre-shared keys associated with the same encrypted session. For this reason, when some encrypted data is received, each node may sequentially select one pre-shared key from the plurality of pre-shared keys held in association with the same encrypted session and attempt to decrypt the received data.

By using the pre-shared key, it is possible to further increase the encryption strength of the encrypted session. In addition, by using the pre-shared key, it is possible to restrict access from nodes other than those with which the encrypted session has been established.

When a digital certificate associated with the public key is available, the public key may be verified using the digital certificate, such as after sequence SQ8. The verification of the public key using the digital certificate may include at least one of querying a certificate authority and accessing a repository. When the verification of the public key using the digital certificate fails, the process of establishing the encrypted session may be stopped.

When a blacklist or a whitelist is prepared in any node, whether or not permit the establishment of an encrypted session may be determined based on the blacklist or the whitelist. For example, establishing an encrypted session with a node having a network address registered in the blacklist may be prohibited. Establishing an encrypted session only with a node having a network address registered in the whitelist may be permitted.

By using the authentication scheme according to the present embodiment, it is guaranteed that each node has a public key (and a private key that pairs with the public key) held by another node with which the node communicates. That is, from the perspective of each node, it is guaranteed that a node with a specific key pair is a communication partner. Thus, in the authentication scheme according to the present embodiment, other nodes are authenticated and identified by using a cryptographic method.

The network address identified through the above-described processes can also be referred to as an authenticated network address. Hereinafter, some examples of a networked system using the authenticated network address will be described.

### C. Node

In this specification, the term “node” includes a physical or virtual computing resource that can have a network address. One node may have a plurality of network addresses. In this case, one node will have a plurality of key pairs.

One computing device (hereinafter, also simply referred to as a “device”) may correspond to one node, or may correspond to a plurality of nodes. The device may be, for example, a general-purpose computer, a special-purpose computer, a smartphone, a tablet, a smart speaker, a wearable device, and the like. In addition, the device may also be, for example, a mobile device, such as a vehicle, an aircraft, a helicopter, a drone, a ship, a train, and a spacecraft. That is, the device may be at least a part of a terrestrial moving device, an airborne moving device, a space moving device, a surface moving device, or an underwater moving device. For example, vehicles can exchange information with each other autonomously.

For example, when a device provides a virtual environment, each of a plurality of virtual machines deployed in the virtual environment may correspond to a node. A cloud server may provide the virtual environment.

A plurality of devices may correspond to one node. For example, in a configuration in which a plurality of devices provide a single service or run an application, the plurality of devices may be collectively treated as a single computing resource.

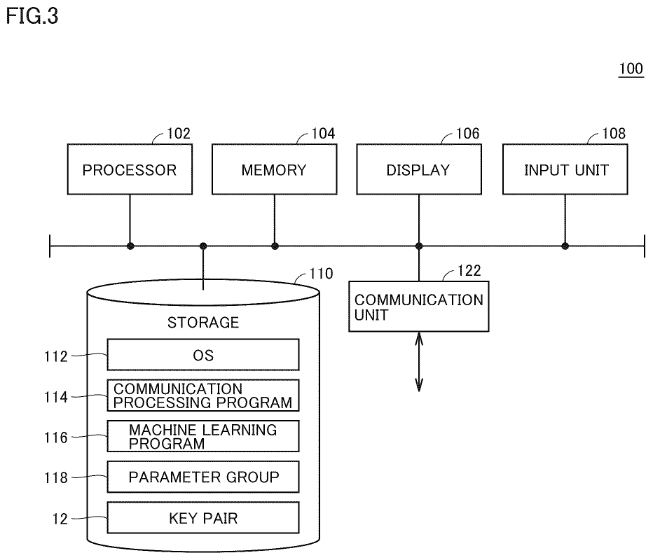

FIG. 3 is a schematic diagram showing an example of the hardware configuration of a node according to the present embodiment. FIG. 3 shows an example of the hardware configuration of a device 100, which is a personal computer, as an example of a node.

Referring to FIG. 3, the device 100 includes one or more processors 102, one or more memories 104, storage 110, a display 106, an input unit 108, and a communication unit 122.

The processor 102 is an arithmetic circuit that sequentially reads and executes computer-readable instructions. The processor 102 is configured by, for example, a CPU (Central Processing Unit) or a GPU (Graphics Processing Unit). The device 100 may have a plurality of processors 102, or a single processor 102 may have a plurality of cores.

In this specification, the term “processor” includes an ASIC (Application Specific Integrated Circuit) and an FPGA (Field-Programmable Gate Array). The processor 102 may be implemented as a System on Chip (SoC). The processor 102 may also be referred to as processing circuitry.

The memory 104 is, for example, a volatile storage device such as a dynamic random access memory (DRAM) or a static random access memory (SRAM). The storage 110 is, for example, a non-volatile storage device such as a hard disk drive (HDD) or a solid state drive (SSD).

In this specification, the term “memory” includes a volatile storage device such as the memory 104 and a non-volatile storage device such as the storage 110.

The storage 110 stores various programs, various kinds of data, various parameters, and the like. The processor 102 performs various processes by loading designated programs, among the various programs stored in the storage 110, onto the memory 104 and executing these programs sequentially.

As an example, the storage 110 stores an operating system (OS) 112, a communication processing program 114, a machine learning program 116, a parameter group 118, and a key pair 12.

The OS 112 includes computer-readable instructions for providing an environment for executing various processes on the device 100. The communication processing program 114 includes computer-readable instructions for executing an authentication scheme according to the present embodiment. The communication processing program 114 may include computer-readable instructions for a communication processing module 20, which will be described later. The machine learning program 116 includes computer-readable instructions for a machine learning processing engine, which will be described later. The parameter group 118 is information for defining the operation of a model included in the machine learning processing engine.

The key pair 12 includes a private key and a public key of the node. In addition, instead of the key pair 12, only the private key may be stored. The key pair 12 or the private key may be stored in a TPM prepared separately from the storage 110.

The display 106 presents the processing results of the processor 102 and the like to the outside. The display 106 may be, for example, an LCD (Liquid Crystal Display) or an organic EL (Electro-Luminescence) display.

The input unit 108 receives a user operation on the device 100 and the like. The input unit 108 may be, for example, a keyboard, a mouse, a touch panel arranged on the display 106, or a switch arranged somewhere on the housing of the device 100.

The display 106 and the input unit 108 may be omitted. The communication unit 122 performs data communication with other nodes. More specifically, the communication unit 122 includes a network interface for connecting the device 100 to the network. For example, the communication unit 122 includes a wired connection terminal such as an Ethernet port, a USB (Universal Serial Bus) port, a serial port such as IEEE1394, or a parallel port. Alternatively, the communication unit 122 may include a processing circuit, an antenna, and the like for wireless communication with a device, a router, a mobile base station, and the like. The wireless communication supported by the communication unit 122 may be, for example, Wi-Fi (registered trademark), Bluetooth (registered trademark), ZigBee (registered trademark), LPWA (Low Power Wide Area), GSM (registered trademark), W-CDMA, CDMA200, LTE (Long Term Evolution), the fifth generation mobile communication system (5G), or the sixth generation mobile communication system (6G).

The device 100 may include components for reading computer-readable instructions from non-transitory media on which computer-readable instructions and the like are stored. The medium may be, for example, an optical medium such as a DVD (Digital Versatile Disc) or a semiconductor medium such as a USB memory.

In addition, instead of installing a program or the like on the device 100 through a medium, necessary programs and the like may be acquired from a distribution server on the network.

In addition, the node according to the present embodiment is not limited to the device 100 shown in FIG. 3, and any hardware configuration according to the required functions and the times in which these will be implemented may be adopted.

In addition, a sensor or an actuator may also correspond to a node. In the networked system according to the present embodiment, nodes may include a device in which no machine learning processing engine is implemented. When a sensor or an actuator corresponds to one node, the authentication scheme described above can be used to authenticate, for example, a sensor that collects a value and an actuator to which a command is given.

In addition, nodes may be various products or parts of products. For example, nodes may be a home appliance, a car, a smart home device, a drone, an autonomous robot, and the like.

### D. Networked System

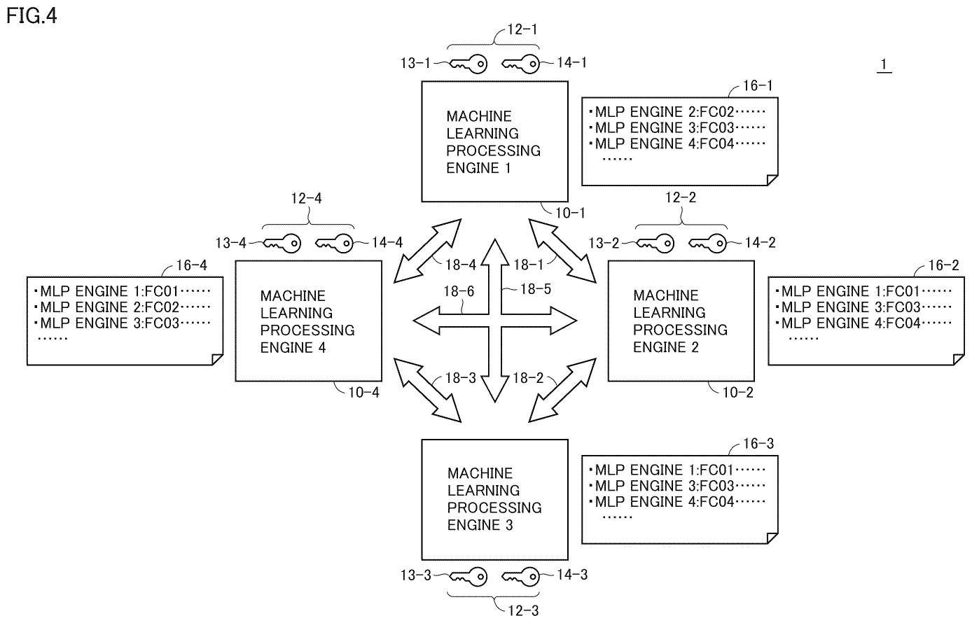

FIG. 4 is a schematic diagram showing an example of the configuration of the networked system according to the present embodiment.

Referring to FIG. 4, a networked system 1 includes a plurality of networked machine learning processing engines 10-1 to 10-4 (hereinafter, may be collectively referred to as “machine learning processing engines 10”). The machine learning processing engines 10-1 to 10-4 can be regarded as “nodes” that are present in the network. Each of the machine learning processing engines 10-1 to 10-4 operates on one or more devices 100.

Each of at least some machine learning processing engines 10 among the plurality of machine learning processing engines 10 includes one or more models. At least some of one or more models may be AI (Artificial Intelligence) models. The model may also be referred to as a trained model. The model includes an algorithm and a parameter group according to the task.

Each of at least some machine learning processing engines 10 among the plurality of machine learning processing engines 10 includes an agent. The agent is responsible for interacting with, for example, a user or other machine learning processing engines 10. In addition, the agent may use the trained model to perform the requested task.

For example, the agent may pass information received from the user or another machine learning processing engine 10 to the model to obtain an inference result and return the inference result to the source of the information. The agent may perform a requested task by linking a plurality of models.

When the agent determines that its own machine learning processing engine 10 cannot adequately respond to at least some of the requests or inquiries from the user or another machine learning processing engine 10, the agent may transfer at least some of the requests or inquiries to another machine learning processing engine 10. The machine learning processing engine 10 at the transfer destination may perform processing in response to the request or inquiry. Alternatively, the agent may respond to the sender of the request or inquiry by introducing another machine learning processing engine 10 that can handle the request or inquiry determined that adequate handling by its own machine learning processing engine 10 is not possible. That is, the agent may introduce to the requester another machine learning processing engine 10 that can respond to the request or inquiry. By adopting such a transfer or introduction process, the need for one machine learning processing engine 10 to be all-purpose is reduced, and a plurality of machine learning processing engines 10 can work together to execute requested tasks.

The number of machine learning processing engines 10 included in the networked system 1 can be determined arbitrarily. The machine learning processing engines 10 may have different structures or functions, or may have the same structure or function.

Each of the plurality of machine learning processing engines 10 may include one or more agents and one or more models.

In the networked system 1, various model operations are possible for at least some of the plurality of machine learning processing engines 10. For example, it is possible to implement MLOps.

In the networked system 1, one machine learning processing engine 10 can manage or execute model operations on its own, or a plurality of machine learning processing engines 10 can work together to manage or execute model operations.

For example, information output from a certain machine learning processing engine 10 may be received by another machine learning processing engine 10 to train or retrain a model of another machine learning processing engine 10.

For example, information output from a certain machine learning processing engine 10 may be received by another machine learning processing engine 10, and another machine learning processing engine 10 may perform inference based on the received information. In addition, another machine learning processing engine 10 may return the inference result to the certain machine learning processing engine 10, or may pass the inference result to yet another machine learning processing engine 10.

For example, a plurality of machine learning processing engines 10 may work together to execute one task.

For example, the evaluation results of a model in a certain machine learning processing engine 10 may be received by another machine learning processing engine 10, and another machine learning processing engine 10 may determine whether or not retraining of the model is necessary based on the received evaluation results. Another machine learning processing engine 10 may provide the certain machine learning processing engine 10 with information necessary for retraining.

For example, tasks such as a game or simulation in which the machine learning processing engines 10 compete against each other may be executed.

For example, the machine learning processing engines 10 may communicate with each other in natural language. Such interactions can improve the model's language understanding or generation capabilities.

In this manner, in the networked system 1, various kinds of information necessary for model operations are exchanged between the plurality of machine learning processing engines 10. In order to perform secure information exchange, in the networked system 1, the authenticated network addresses described above are used.

More specifically, the machine learning processing engines 10-1 to 10-4 have key pairs 12-1 to 12-4, respectively. The key pairs 12-1 to 12-4 include private keys 13-1 to 13-4 and public keys 14-1 to 14-4, respectively. As described above, the private keys 13-1 to 13-4 are used to uniquely determine the network addresses of the machine learning processing engines 10-1 to 10-4, respectively.

For example, the process of authenticating the network address shown in FIG. 2 may be handled by the agent included in each of the machine learning processing engines 10-1 to 10-4.

The machine learning processing engines 10-1 to 10-4 may have communication partner settings 16-1 to 16-4, respectively. The communication partner settings 16-1 to 16-4 include information for identifying one or more other machine learning processing engines 10 that are scheduled to exchange information with the machine learning processing engines 10-1 to 10-4.

For example, the communication partner settings 16-1 to 16-4 may be a kind of whitelist. Specifically, each of the communication partner settings 16-1 to 16-4 may include information (in the example of FIG. 4, the name) for identifying the machine learning processing engine 10 set in advance as a communication partner and the corresponding network address. Each of the machine learning processing engines 10-1 to 10-4 has, for example, the communication partner settings 16-1 to 16-4 in which information indicating the other machine learning processing engines 10 is associated with the network addresses of the other machine learning processing engines 10. In addition, the communication partner settings 16-1 to 16-4 may include the corresponding public keys instead of or in addition to the network addresses. The communication partner settings 16-1 to 16-4 may be managed by the communication processing module 20, which will be described later.

For example, the machine learning processing engine 10-1 establishes encrypted sessions 18-1, 18-5, and 18-4 with the machine learning processing engines 10-2 to 10-4, respectively. The machine learning processing engine 10-2 establishes encrypted sessions 18-1, 18-3, and 18-6 with the machine learning processing engines 10-1, 10-3, and 10-4, respectively. The machine learning processing engine 10-3 establishes encrypted sessions 18-5, 18-2, and 18-3 with the machine learning processing engines 10-1, 10-2, and 10-4, respectively. The machine learning processing engine 10-4 establishes encrypted sessions 18-4, 18-6, and 18-3 with the machine learning processing engines 10-1 to 10-3, respectively.

For example, the process for establishing the encrypted session 18-1 may be started by any of the machine learning processing engines 10-1 and 10-2. When the machine learning processing engine 10-1 starts communication with the machine learning processing engine 10-2, the machine learning processing engine 10-1 may transmit a handshake initiation message addressed to the network address of the machine learning processing engine 10-2 by referring to the communication partner setting 16-1. Alternatively, the machine learning processing engine 10-1 may determine the network address of the machine learning processing engine 10-2 from the public key 14-2 of the machine learning processing engine 10-2 and transmit a handshake initiation message addressed to the determined network address. In addition, similar processing is also performed when the machine learning processing engine 10-2 starts communication with the machine learning processing engine 10-1.

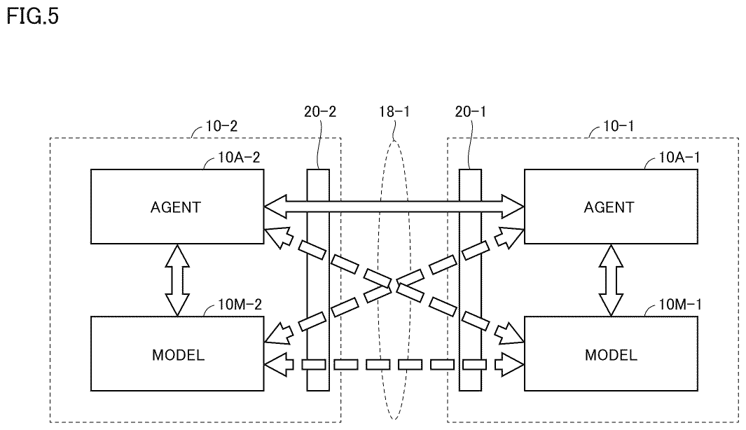

FIG. 5 is a schematic diagram showing a more detailed configuration example of the machine learning processing engine 10 shown in FIG. 4. For the convenience of explanation, FIG. 5 focuses on the machine learning processing engines 10-1 and 10-2, but the other machine learning processing engines 10 may also have a similar configuration.

Referring to FIG. 5, the machine learning processing engine 10-1 includes an agent 10A-1 and a model 10M-1. The machine learning processing engine 10-2 includes an agent 10A-2 and a model 10M-2.

The machine learning processing engine 10-1 may include a communication processing module 20-1. The machine learning processing engine 10-2 may include a communication processing module 20-2.

The communication processing modules 20-1 and 20-2 (hereinafter, also collectively referred to as “communication processing modules 20”) are implemented, for example, in Layer 3 (network layer) and are responsible for the above-described authentication scheme. More specifically, the communication processing module 20 identifies the other machine learning processing engines 10 using a cryptographic method. Since the communication processing module 20 is responsible for the processing for authenticating and identifying the other machine learning processing engines 10 (or the agent 10A or the model 10M), there is no need to implement the processing required for the authentication scheme in the agents 10A-1 and 10A-2 (hereinafter, collectively referred to as “agents 10A”) and the models 10M-1 and 10M-2 (hereinafter, collectively referred to as “models 10M”).

In addition, the agent 10A may include all or some of the functions of the communication processing module 20.

For example, the encrypted session 18-1 is established between the communication processing module 20-1 and the communication processing module 20-2. The agent 10A-1 and the agent 10A-2 may exchange information through the encrypted session 18-1. In this case, the agent 10A-1 passes information to the model 10M-1 and receives the inference results from the model 10M-1. Similarly, the agent 10A-2 passes information to the model 10M-2 and receives inference results from the model 10M-2.

The agent 10A-1 and the model 10M-2 may exchange information, the agent 10A-2 and the model 10M-1 may exchange information, or the model 10M-1 and the model 10M-2 may exchange information.

By using the authentication scheme according to the present embodiment, the machine learning processing engine 10 can authenticate and identify the machine learning processing engine 10 of the communication partner. In addition, encryption can improve the security of information exchanged between the machine learning processing engines 10.

In addition, by implementing the authentication scheme according to the present embodiment in Layer 3 (network layer), there is no need to implement processing for authenticating and identifying the communication partner in Layer 7 (application layer) of the OSI reference model, which performs the main processing of the machine learning processing engine 10.

In the networked system according to the present embodiment, each of the plurality of machine learning processing engines 10 executes model operations by exchanging information with another machine learning processing engine 10 according to the interrelationship between the machine learning engine itself and another machine learning processing engine 10. That is, each of the plurality of machine learning processing engines 10 determines the content of information to be exchanged with another machine learning processing engine 10 or the processing content of the model operation to be executed, according to which type of communication partner another machine learning processing engine 10 is with respect to the host machine learning processing engine.

Each of the plurality of machine learning processing engines 10 may determine in advance the authority to be granted to another machine learning processing engine 10. That is, each of the plurality of machine learning processing engines 10 may change the processing content of the model operation according to the authority granted to another machine learning processing engine 10.

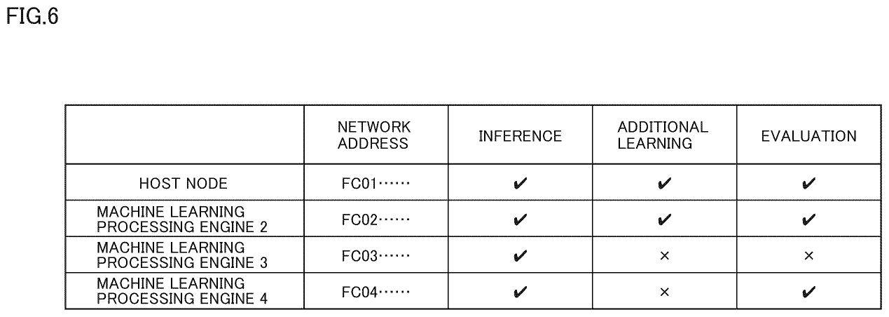

FIG. 6 shows an example of authority settings in the networked system according to the present embodiment. For the convenience of explanation, FIG. 6 shows an example of authority settings for the machine learning processing engine 10-1.

Referring to FIG. 6, for example, in addition to the machine learning processing engines 10-2 to 10-4 that are scheduled to exchange information with the machine learning processing engine 10-1, the scope of authority to be granted is also set for the host node (machine learning processing engine 10-1).

In the example shown in FIG. 6, inference, additional learning, and evaluation are shown as examples of types of authority. Inference means the authority of the target machine learning processing engine 10 to provide information to the machine learning processing engine 10-1 to obtain an inference result. Additional learning means the authority of the target machine learning processing engine 10 to cause the machine learning processing engine 10-1 to perform additional learning. Evaluation means the authority of the target machine learning processing engine 10 to obtain an evaluation of the model from the machine learning processing engine 10-1.

In this manner, each of the machine learning processing engines 10-1 to 10-4 may have settings in which the network address of another machine learning processing engine 10 is associated with one or more authorities to be granted to another machine learning processing engine 10.

The machine learning processing engine 10 may determine the scope of the authority to be granted based on the authenticated network address of another machine learning processing engine 10 (or node) and the like. That is, the machine learning processing engine 10 may determine the authority to be granted to another machine learning processing engine 10 according to predetermined settings. The process of determining such authority may be performed by the communication processing module 20 or the agent 10A. The machine learning processing engine 10 may receive access from another machine learning processing engine 10 within the scope of the granted authority.

Each of the plurality of machine learning processing engines 10 executes model operations by exchanging information with another machine learning processing engine 10 based on the determined authority. Each of the plurality of machine learning processing engines 10 manages or executes model operations by exchanging information with another machine learning processing engine 10 within the scope of the authority granted to another machine learning processing engines 10.

In addition to the authorities shown in FIG. 6 or instead of the authorities, a role to be assigned to the machine learning processing engine 10 may be determined in advance. The role is also an example of the interrelationship between a certain machine learning processing engine 10 and another machine learning processing engine 10. The role may be, for example, to provide information for additional learning or to monitor the performance of the model.

In addition, the authority or role set for each machine learning processing engine 10 may be determined or updated autonomously by one of the machine learning processing engines 10. That is, the interrelationship between a certain machine learning processing engine 10 and another machine learning processing engine 10 may be dynamically determined or changed according to various situations or conditions.

In addition, when a digital certificate associated with a public key is used, the authority and/or role to be granted to the corresponding machine learning processing engine 10 (or node) may be described in the digital certificate. The machine learning processing engine 10 (or node) may determine the authority and/or role to be granted to the machine learning processing engine 10 (or node) of the communication partner based on the acquired digital certificate.

Thus, since the authority or role can be set for each machine learning processing engine 10, it is possible to flexibly configure a networked system according to the purpose.

As a modification example, the machine learning processing engine 10 may receive requests from a variety of sources.

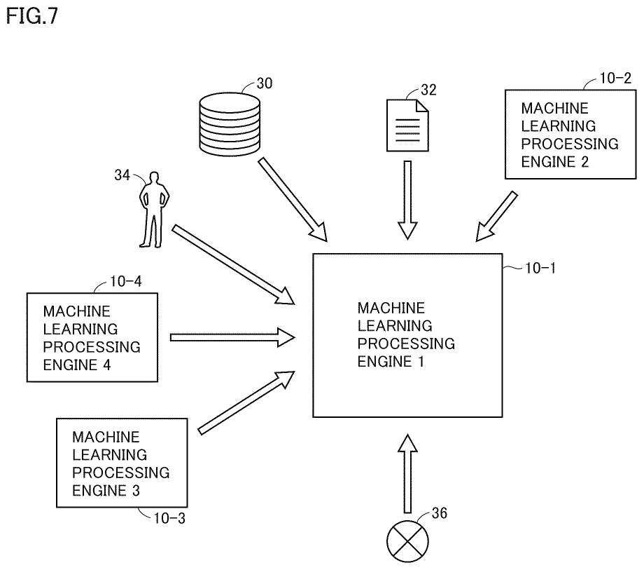

FIG. 7 is a diagram showing an example of model operations of the machine learning processing engine 10 according to the present embodiment. For the convenience of explanation, FIG. 7 focuses on the machine learning processing engine 10-1 shown in FIG. 4, but the other machine learning processing engines 10 may also be a similar configuration example.

Referring to FIG. 7, the machine learning processing engine 10-1 receives task requests or information from the machine learning processing engines 10-2 to 10-4.

The machine learning processing engine 10-1 may receive task requests or information from a preprocessing layer 30. The preprocessing layer 30 is responsible for, for example, processing for transformation into information suitable for processing by the machine learning processing engine 10. The preprocessing layer 30 may perform tasks such as voice recognition, image processing, and translation. The preprocessing layer 30 may be, for example, a transformer.

The machine learning processing engine 10-1 may receive any document 32 as its input. The machine learning processing engine 10-1 may receive a request or information from a user 34 as its input. The machine learning processing engine 10-1 may receive information from a sensor 36 as its input. The machine learning processing engine 10-1 may output information to an actuator (not shown).

In any case, the machine learning processing engine 10-1 authenticates and identifies the communication partner using the authentication scheme. For example, when the preprocessing layer 30 is a communication partner, a node including the preprocessing layer 30 is authenticated and identified. When the document 32 is input, a node holding the document 32 is authenticated and identified. When a request or information from the user 34 is received as input, a device used by the user 34 is authenticated and identified. The sensor 36 or the actuator may include a circuit or logic that executes the authentication scheme.

As a modification example, one machine learning processing engine 10 may be implemented by a plurality of devices 100.

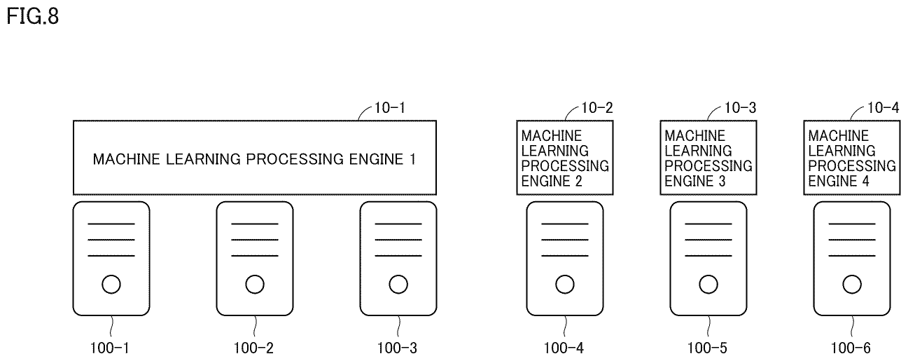

FIG. 8 is a schematic diagram showing an example of implementation of the machine learning processing engine 10 according to the present embodiment. In the implementation example shown in FIG. 8, the machine learning processing engine 10-1 is implemented by three devices 100-1 to 100-3, and the machine learning processing engines 10-2 to 10-4 are implemented by devices 100-4 to 100-6, respectively.

Each of the devices 100-1 to 100-6 may be a single node. In this case, each of the devices 100-1 to 100-6 has a network address (or a key pair) unique to the device. Alternatively, each of the machine learning processing engines 10-1 to 10-4 may be a single node. In this case, the devices 100-1 to 100-3 may share a network address (or a key pair).

In any case, the devices 100-1 to 100-6 execute the authentication scheme.

By implementing the machine learning processing engine 10 with a plurality of devices, for example, distributed parallel learning can be performed. Distributed parallel learning includes, for example, data parallelism, model parallelism, pipeline parallelism, hybrid parallelism, and the like.

Since one machine learning processing engine 10 is implemented by a plurality of devices 100 using a plurality of devices, it is possible to realize the machine learning processing engine 10 having a large-scale model.

As a modification example, a plurality of machine learning processing engines 10 may have common core parameters, and fine tuning may be performed based on information from each of the machine learning processing engines 10.

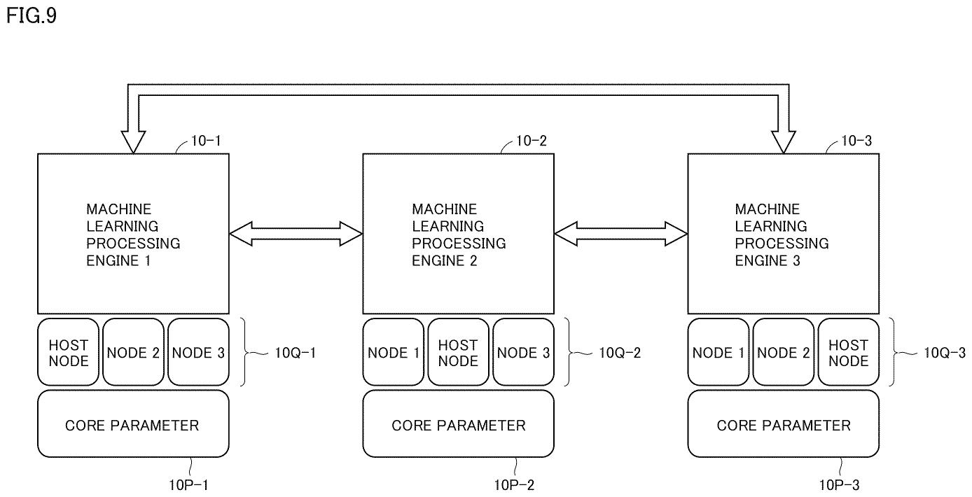

FIG. 9 is a schematic diagram showing an example of sharing core parameters according to the present embodiment. For the convenience of explanation, an example of the configuration in which the machine learning processing engines 10-1 to 10-3 have common core parameters is shown, but the number of machine learning processing engines 10 may be any number.

Referring to FIG. 9, the machine learning processing engines 10-1 to 10-3 have common core parameters 10P-1 to 10P-3, respectively. The core parameters 10P-1 to 10P-3 are independent parameter groups (see the parameter group 118 and the like in FIG. 3).

The machine learning processing engine 10-1 adds or updates a specific parameter 10Q-1 according to the training and the like in the machine learning processing engine 10-1 (its own node), and adds or updates the specific parameter 10Q-1 according to the inference results and the like of the machine learning processing engine 10-2 (node 2) or the machine learning processing engine 10-3 (node 3). The machine learning processing engine 10-1 can identify which machine learning processing engine 10 the specific parameter 10Q-1 originates from. For this reason, the machine learning processing engine 10-1 may manage the specific parameter 10Q-1 separately for each originating machine learning processing engine 10.

Similarly, the machine learning processing engine 10-2 adds or updates a specific parameter 10Q-2 according to the training and the like of the machine learning processing engine 10-2 (its own node), and adds or updates the specific parameter 10Q-2 according to the inference results and the like of the machine learning processing engine 10-1 (node 1) or the machine learning processing engine 10-3 (node 3). Similarly to the machine learning processing engines 10-1 and 10-2, the machine learning processing engine 10-3 adds or updates a specific parameter 10Q-3.

In the configuration example shown in FIG. 9 as well, the machine learning processing engines 10-1 to 10-3 authenticate and identify the communication partner using the authentication scheme.

For such common core parameters, adding or updating parameters for each node enables node-specific model operations in each machine learning processing engine 10 (node).

As a modification example, a plurality of nodes may access one machine learning processing engine 10.

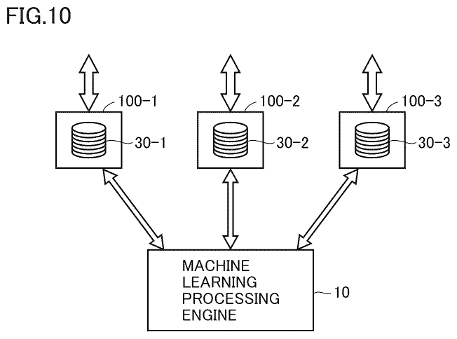

FIG. 10 is a diagram showing an example of the configuration in which a plurality of nodes access the machine learning processing engine 10 according to the present embodiment. Referring to FIG. 10, devices 100-1 to 100-3 can access the machine learning processing engine 10. The machine learning processing engine 10 may be a single node, and the devices 100-1 to 100-3 may each be an independent node.

The machine learning processing engine 10 may authenticate and identify each of the devices 100-1 to 100-3 using the authentication scheme.

The devices 100-1 to 100-3 have preprocessing layers 30-1 to 30-3, respectively.

Similarly to the preprocessing layer 30 described above, the preprocessing layers 30-1 to 30-3 are responsible for, for example, processing for transformation into information suitable for processing by the machine learning processing engine 10.

The processing results of the preprocessing layers 30-1 to 30-3 may be passed to the machine learning processing engine 10, or the inference results of the machine learning processing engine 10 may be passed to any of the preprocessing layers 30-1 to 30-3. The preprocessing layers 30-1 to 30-3 do not need to be the same, and may have different performance or functions according to the devices 100-1 to 100-3.

A networked system in which one or more modification examples described above are combined may be constructed.

### E. Modification Example

In the above embodiment, an example of processing has been described in which the machine learning processing engine 10 to be a communication partner is identified by establishing an encrypted session by processing based on asymmetric encryption. That is, an example of a process of identifying other machine learning processing engines using a cryptographic method has been described. However, other machine learning processing engines may be identified using, for example, a protocol such as SSL/TLS.

### F. Advantages

According to the networked system according to the present embodiment, a plurality of machine learning processing engines can execute model operations while exchanging information. This enables each machine learning processing engine to autonomously evolve and improve. At this time, by executing model operations according to the interrelationship between machine learning processing engines, it is possible to flexibly construct a networked system for various applications or purposes.

By using the authentication scheme according to the present embodiment, it is possible, between machine learning processing engines, to securely and efficiently authenticate network addresses, identify the machine learning processing engines, and determine the authorities or roles to be granted to the machine learning processing engines.

It should be considered that the embodiment disclosed is an example in all points and not restrictive. The scope of the present invention is defined by the claims rather than the above description, and is intended to include all modifications within the scope and meaning equivalent to the claims.

### EXPLANATIONS OF LETTERS OR NUMERALS

1 networked system, 10 machine learning processing engine, 10A agent, 10M model, 10P core parameter, 10Q specific parameter, 12 key pair, 13 private key, 14 public key, 16 communication partner setting, 18 encrypted session, 20 communication processing module, 30 preprocessing layer, 32 document, 34 user, 100 device, 102 processor, 104 memory, 106 display, 108 input unit, 110 storage, 114 communication processing program, 116 machine learning program, 118 parameter group, 122 communication unit.

1. A networked system, comprising:
a plurality of machine learning processing engines,
wherein each of the plurality of machine learning processing engines is configured to operate on one or more computing devices,
each of the plurality of machine learning processing engines includes identification means for identifying another machine learning processing engine using a cryptographic method, and
each of the plurality of machine learning processing engines executes a model operation by exchanging information with the another machine learning processing engine according to an interrelationship between the machine learning processing engine and the identified another machine learning processing engine.

2. The networked system according to claim 1,
wherein each of the plurality of machine learning processing engines further includes determination means for determining, in accordance with a predetermined setting, an authority to be granted to the identified another machine learning processing engine.

3. The networked system according to claim 2,
wherein the predetermined setting associates a network address of another machine learning processing engine with one or more authorities to be granted to the another machine learning processing engine.

4. The networked system according to claim 1,
wherein each of the plurality of machine learning processing engines has a setting in which information indicating another machine learning processing engine is associated with a network address of the another machine learning processing engine.

5. The networked system according to claim 1,
wherein the identification means authenticates a network address of the another machine learning processing engine.

6. The networked system according to claim 1,
wherein each of the plurality of machine learning processing engines has a private key used for identification by the cryptographic method.

7. The networked system according to claim 1,
wherein the model operation includes at least one of data collection, preprocessing of collected data, model training, model evaluation, model deployment, inference using a model, monitoring of model performance, model maintenance, and model retraining.

8. An information processing method in a system including a plurality of machine learning processing engines,
wherein each of the plurality of machine learning processing engines is configured to operate on one or more computing devices,
the information processing method comprising:
a step in which each of the plurality of machine learning processing engines identifies another machine learning processing engine using a cryptographic method; and
a step in which each of the plurality of machine learning processing engines executes a model operation by exchanging information with the another machine learning processing engine according to an interrelationship between the identified another machine learning processing engine and the machine learning processing engine.
